(19) United States
(12) Patent Application Publication
(10) Pub. No.: US 2006/0275064 A1
(43) Pub. Date: Dec. 7, 2006

(54) Information Processing Apparatus, Control Method for Use in Copying an Original Document, Program, and Storage Medium

(75) Inventor: Makoto Minari, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/421,628

(22) Filed: Jun. 1, 2006

(30) Foreign Application Priority Data
Jun. 2, 2005 (JP) 2005-163190

(51) Int. Cl. G03G 21/00

(52) U.S. Cl. 399/366

(57) ABSTRACT

A method and apparatus for restricting a copying operation of an original document comprising obtaining copy information added to an original document, copying the original document based on the copy information, and updating the copy information added to the original document based on the copying of the original document.

### BACKGROUND OF THE INVENTION

1. Field of the Invention

The present invention relates to an information processing apparatus, a control method for use in copying an original document, a program, and a storage medium.

2. Description of the Related Art

A conventional printing apparatus is capable of printing electronic information of electronic publications on a paper sheet. In this type of printing apparatus, in order to prevent electronic information from being unlimitedly printed, a technology for limiting the number of times of printing by adding, to the electronic information, information indicating an allowable number of times of printing is known (see, for example, Japanese Patent Application Laid-Open No. 2001-184184).

Meanwhile, a technology has been disclosed in which a radio frequency (RF) tag, which contains digital data, is embedded in a sheet of printing paper (see, for example, U.S. Patent Application Publication No. US 2002/0170973 A1 (corresponding to Japanese Patent Application Laid-Open No. 2002-337426)). According to this technology, a program and an instruction manual for the program can be distributed at the same time by printing the instruction manual on a sheet of printing paper in which an RF tag storing the program is embedded.

### SUMMARY OF THE INVENTION

The present invention includes a method of restricting a copying operation for an original document.

The present invention also includes a method of updating copying information added to an original document and restricting a copying operation based on the updated copying information.

In one aspect of the present invention, an information processing apparatus includes a reading unit configured to read an image on an original document, an obtaining unit configured to obtain copy information added to the original document, a printing unit configured to print the image read by the reading unit in accordance with the copy information obtained by the obtaining unit, and an updating unit configured to update the copy information added to the original document in accordance with printing performed by the printing unit.

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram illustrating an example of a configuration of a printing apparatus according to an embodiment of the present invention.

FIG. 2 is a block diagram illustrating an example of a configuration of a radio frequency (RF) tag control unit as shown in FIG. 1.

FIG. 3 is a block diagram illustrating a configuration of the RF tag.

FIG. 4 is a diagram illustrating an RF tag-attached printing sheet in which the RF tag is embedded.

FIG. 5 is a flow chart illustrating a procedure for a copy allowance information attachment processing performed by a CPU of the printing apparatus shown in FIG. 1.

FIG. 6 is a flow chart illustrating an example of a copy processing performed by the CPU of the printing apparatus shown in FIG. 1.

FIG. 7 is a flow chart illustrating an example of steps to be taken in a modification of the embodiment of the copying processing shown in FIG. 6.

FIG. 8 is a flowchart illustrating an example of steps to be taken in another modification of the embodiment of the copying processing shown in FIG. 6.

FIG. 9 is a flow chart illustrating an example of steps to be taken in a modification of the embodiment of the copy allowance information attachment processing shown in FIG. 5.

FIG. 10 is a diagram illustrating an example of an input screen for inputting the number of copies to make displayed in step S605 of FIG. 6.

FIG. 11 is a diagram illustrating an example of a warning message displayed in step S616 of FIG. 6.

FIG. 12 is a diagram illustrating an example of a warning message displayed in step S607 of FIG. 6.

FIG. 13 is a diagram illustrating an example of a warning message displayed in step S701 of FIG. 7.

FIG. 14 is a diagram illustrating an example of a transfer copy number input screen displayed in step S801 of FIG. 8.

FIG. 15 is a diagram illustrating an example of a copy allowance information input screen displayed in step S902 of FIG. 9.

### DETAILED DESCRIPTION OF THE EMBODIMENTS

Exemplary embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

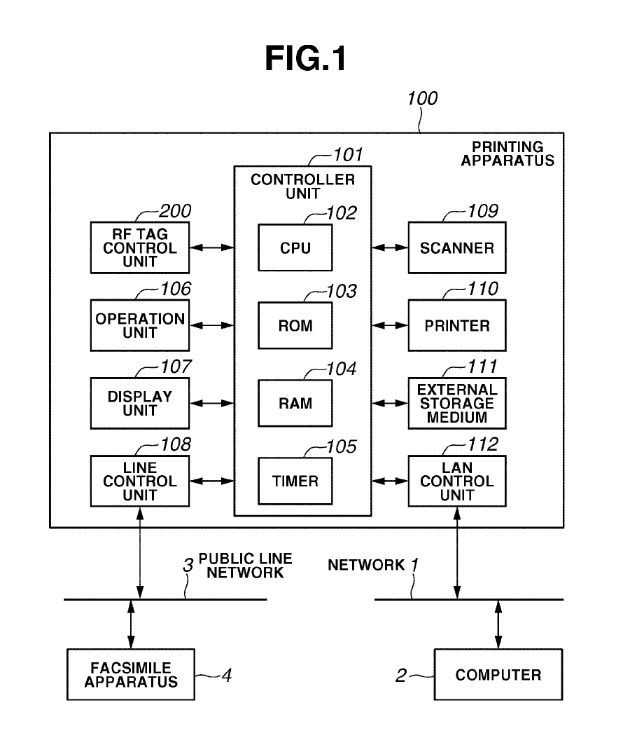

FIG. 1 is a block diagram illustrating a configuration of a printing apparatus 100 according to an embodiment of the present invention.

In FIG. 1, the printing apparatus 100 is a multi-function printing apparatus equipped with a copying function, a printer function, a scanner function, and a facsimile communication function.

The printing apparatus 100 includes a controller unit 101 that controls the printing apparatus 100. In addition, the printing apparatus 100 includes an operation unit 106, a display unit 107, a line control unit 108, a scanner 109, a printer 110, an external storage medium 111, a LAN control unit 112, and an RF tag control unit 200. Each of these units is connected to the controller unit 101.

The controller unit 101 includes a CPU 102, a ROM 103, a RAM 104, and a timer 105. Various kinds of programs that the CPU 102 executes and data and the like that the programs require are stored in the ROM 103. In addition, some programs and data can be stored in the external storage medium 111 and can also be read into the RAM 104 and executed.

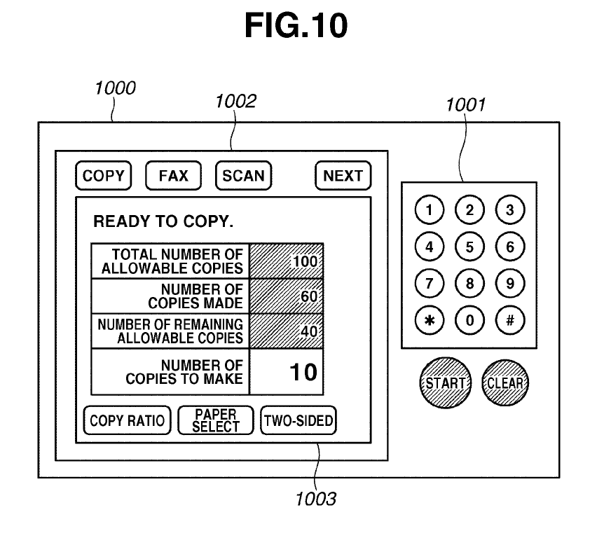

The operation unit 106 and the display unit 107 are configured by an operation unit panel 1000 shown in FIG. 10. The operation unit panel 1000 includes a numeric keypad 1001 for inputting information indicating the number of copies to make, and a liquid crystal display (LCD) panel 1002 for displaying, among other things, information indicating the number of copies to make, as well as various messages relating to processing performance status. The LCD panel 1002 may also include features such as a touch panel, and functions as part of the operation unit 106 when a corresponding key is selected.

The line control unit 108 allows a user to make a telephone call, and sends and receives a facsimile from another facsimile apparatus 4. In addition, the line control unit 108 includes a data encoding/decoding device that encodes image data read by the scanner 109 into a data format suitable for facsimile transmission, and decodes the data received through the facsimile, a modem, and a network control unit (NCU), and the like.

The scanner 109, in performing a copying operation and a facsimile transmission, reads image data from an original document. The printer 110 implements a copying function by printing image data received from the facsimile apparatus 4 via the line control unit 108 and printing data received from a computer 2 via the LAN control unit 112.

The external storage medium 111 stores programs that the CPU 102 executes and image data read by the scanner 109. The LAN control unit 112 communicates with other facsimile apparatuses and the computer 2 via a network 1.

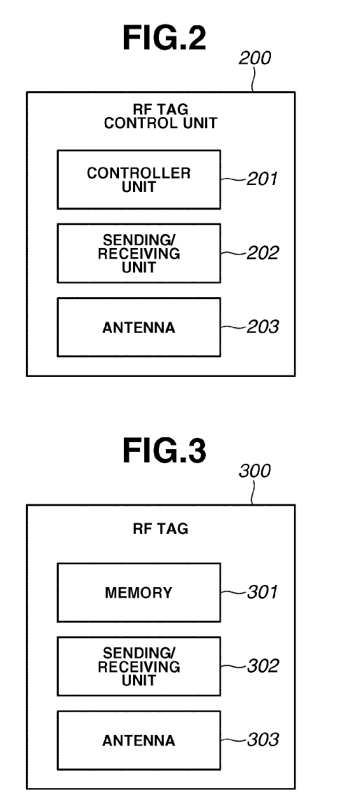

FIG. 2 is a block diagram illustrating a configuration of the RF tag control unit 200 shown in FIG. 1.

In FIG. 2, the RF tag control unit 200 includes a controller unit 201, a sending/receiving unit 202, and an antenna 203.

The controller unit 201 controls the RF tag control unit 200. The sending/receiving unit 202 sends and receives information through wireless communication with an RF tag 300, which is described below, via the antenna unit 203.

FIG. 3 is a block diagram illustrating a configuration of the RF tag 300 controlled by the RF tag control unit 200 shown FIG. 2. Note that an RF tag is also known as a radio frequency identification (RFID) tag or an integrated circuit (IC) tag.

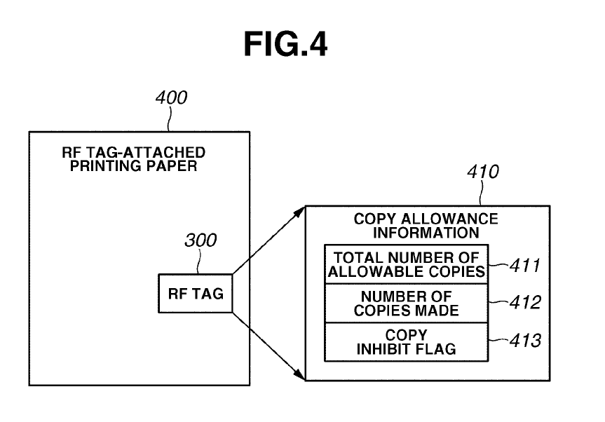

In FIG. 3, the RF tag 300 includes a memory 301, a sending/receiving unit 302, and an antenna 303. The sending/receiving unit 302 sends and receives information by wireless communication with the RF tag control unit 200 via the antenna unit 303. The memory 301 stores copy allowance information 410 shown in FIG. 4, which is described below. The RF tag 300 is, as illustrated in FIG. 4, embedded in an RF tag-attached printing paper sheet 400.

FIG. 4 is a block diagram illustrating a configuration of the RF tag-attached printing paper sheet 400 in which the RF tag 300 shown in FIG. 3 is embedded.

In FIG. 4, copy allowance information 410 is stored in the memory 301 of the RF tag 300. The copy allowance information 410 includes a total number of allowable copies 411 of an original document printed on the RF-tag attached printing paper sheet 400 in which the RF tag 300 is embedded. In addition, the copy allowance information 410 includes a number of copies made 412 that indicates the number of printed copies of the original document, and a copy inhibit flag 413 that indicates whether copying the original document is allowed. The copy inhibit flag 413 is off when copying is allowed, and on when copying is inhibited.

The printing apparatus 100 can write the copy allowance information 410 into the RF tag 300 embedded in the RF tag-attached printing paper sheet 400 by using the RF tag control unit 200. Thus, the copy allowance information 410 may be added to the RF tag-attached printing paper sheet 400.

In addition, the printing apparatus 100 can read the copy allowance information 410 added to the RF tag-attached printing paper sheet 400 by using the RF tag control unit 200. Thus, copying may be allowed or inhibited based on the read copy allowance information 410.

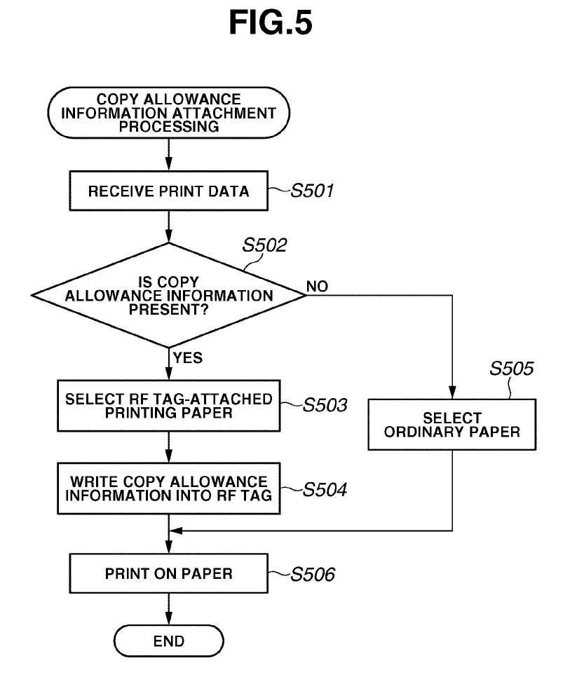

FIG. 5 is a flow chart illustrating a procedure for a copy allowance information attaching processing performed by the CPU 102 of the printing apparatus 100 shown in FIG. 1.

In this processing, when the printing apparatus 100 receives print data from the computer 2 via the network 1 and performs printing based on the received print data, the copy allowance information 410 is added to a printed product.

In FIG. 5, the printing apparatus 100 first receives print data from the computer 2 via the network 1 and the LAN control unit 112 (step S501). Then, a determination is made whether the copy allowance information 410 is included in the received print data (step S502).

If it is determined in step S502 that the copy allowance information 410 is included in the received print data, the printing apparatus 100 selects the RF tag-attached printing paper sheet 400 as a paper sheet to be used for printing (step S503). Then, the printing apparatus 100 writes the copy allowance information 410 included in the print data received in step S501 into the RF tag 300 embedded in the RF tag-attached printing paper sheet 400 by using the RF tag control unit 200 (step S504). Next, the printing apparatus 100 prints the print data received in step S501 on the RF tag-attached printing paper sheet 400 by using the printer 110 (step S506). Then, the processing ends.

If it is determined in step S502 that the copy allowance information 410 is not included in the received print data, the printing apparatus 100 selects an ordinary paper sheet as a paper sheet to be used for printing (step S505). Then, the printing apparatus 100 prints the print data received in step S501 on the ordinary paper sheet by using the printer 110 (step S506). Then, the processing ends.

According to the processing illustrated in FIG. 5, the RF tag control unit 200 writes the copy allowance information 410 included in the print data received in step S501 into the RF tag 300 embedded in the RF tag-attached printing paper sheet 400 (step S504). Then, the printer 110 prints the print data received in step S501 on the RF tag-attached printing paper sheet 400 (step S506). Thus, the copy allowance information 410 is added to a printed product.

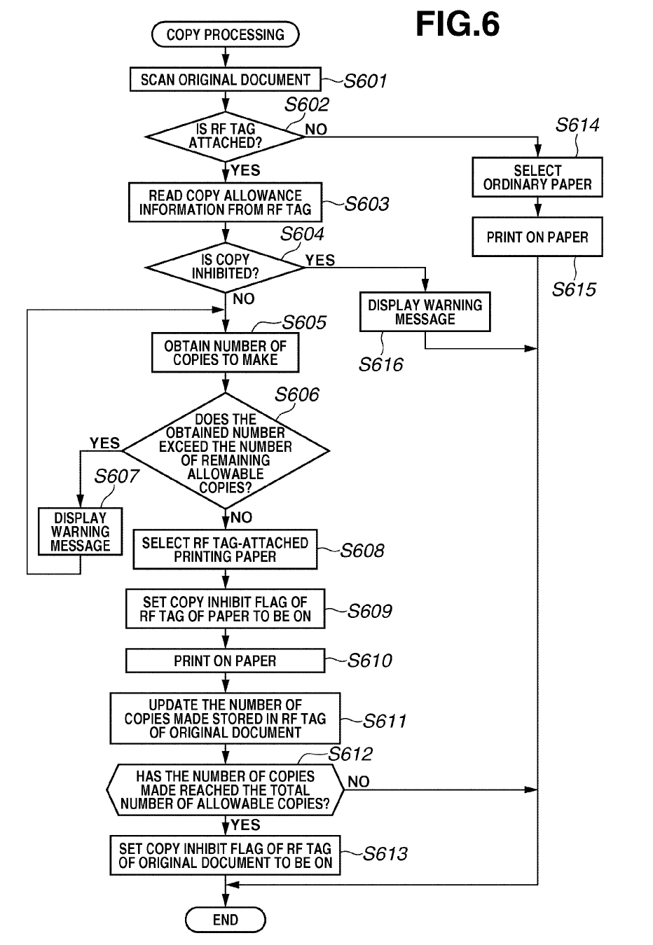

FIG. 6 is a flow chart illustrating an example of a copying processing performed by the CPU 102 of the printing apparatus 100 shown in FIG. 1.

In this processing, an original document having the copy allowance information 410 added thereto is copied.

In FIG. 6, the printing apparatus 100 scans an original document by using the scanner 109 and reads image data from the original document (step S601). Then, the printing apparatus 100 determines whether the scanned original document includes an embedded RF tag 300 (step S602). If it is determined that the RF tag 300 is embedded in the scanned original document, the printing apparatus 100, using the RF tag control unit 200, reads the copy allowance information 410 from the RF tag 300 embedded in the original document (step S603).

Then, the printing apparatus 100 extracts the copy inhibit flag 413 from the read copy allowance information 410, and determines whether copying of the scanned original document is inhibited based on the copy inhibit flag 413 (step S604). If it is determined that copying of the scanned original document is not inhibited, the printing apparatus 100 obtains the number of copies to make inputted by the user via the operation unit 106 (step S605). A user inputs the number of copies to make via an input screen 1003.

In FIG. 10, an LCD panel 1002 displays the input screen 1003 for inputting the number of copies, including the total number of allowable copies, the number of copies made, the number of remaining allowable copies, and the number of copies to make. The total number of allowable copies and the number of copies made are displayed based on the total number of allowable copies 411 and the number of copies made 412 read in step S603. The number of remaining allowable copies is the remaining number of copies obtained by subtracting the number of copies made from the total number of allowable copies. A user using the numeric keypad 1001 inputs the number of copies.

Referring back to FIG. 6, the printing apparatus 100 then determines whether the input number of copies to make exceeds the number of remaining allowable copies (step S606). If it is determined that the input number of copies to make does not exceed the number of remaining allowable copies, the printing apparatus 100 selects the RF tag-attached printing paper sheet 400 as a paper sheet to be used for printing (step S608). Then, the printing apparatus 100, using the RF tag control unit 200, sets the copy inhibit flag 413 of the RF tag 300 embedded in the RF tag-attached printing paper sheet 400 to be on and writes the copy allowance information 410 into the RF tag 300 (step S609). In addition, the printing apparatus 100 prints the image data read from the original document on the RF tag-attached printing paper sheet 400 by using the printer 110 (step S610).

Then, the printing apparatus 100, using the RF tag control unit 200, updates the number of copies made 412 of the RF tag 300 of the original document (step S611), and determines whether the number of copies made 412 of the RF tag 300 of the original document has reached the total number of allowable copies 411 (step S612). If the number of copies made 412 has not yet reached the total number of allowable copies 411, processing ends. On the other hand, if the number of copies made 412 has reached the total number of allowable copies 411, the printing apparatus 100, using the RF tag control unit 200, sets the copy inhibit flag 413 of the RF tag 300 of the original document to be on (step S613). Then, the processing ends.

If it is determined in step S602 that the RF tag 300 is not embedded in the scanned original document, the printing apparatus 100 selects an ordinary paper sheet as a paper sheet to be used for printing (step S614). Then, the printing apparatus 100, using the printer 110, prints the image data read from the original document on the ordinary paper sheet (step S615).

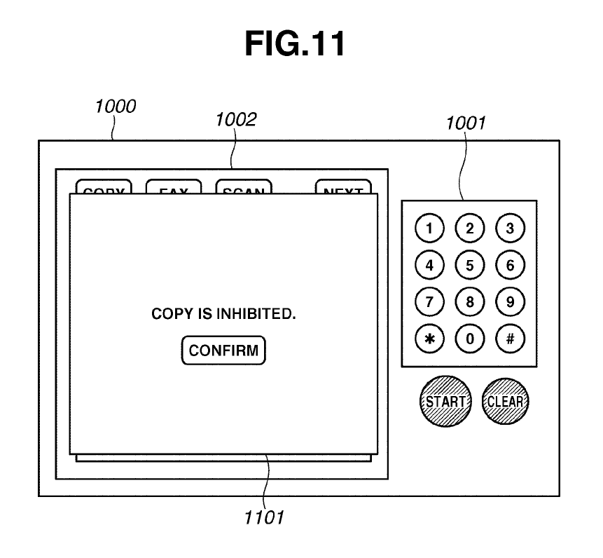

If it is determined in step S604 that copying of the scanned original document is inhibited, the printing apparatus 100 displays a warning message 1101 shown in FIG. 11 on the LCD panel 1002 (step S616). Then, the processing ends. In FIG. 11, the warning message 1101 is displayed on the LCD panel 1002 to notify the user that copying of the scanned original document is inhibited. When the user selects a “Confirm” key, the warning message 1101 is no longer displayed.

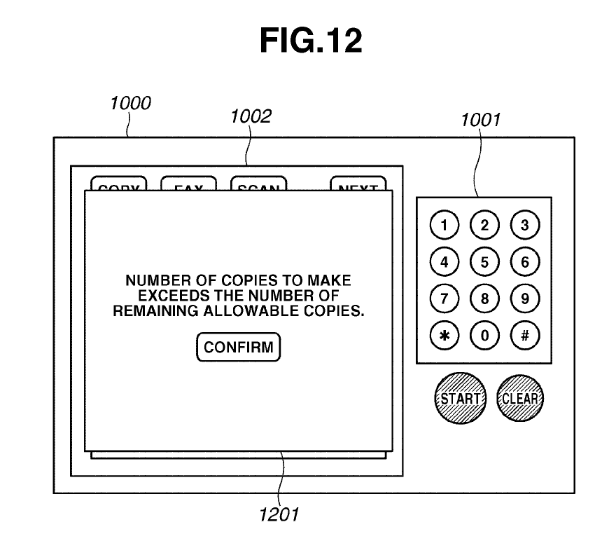

If it is determined in step S606 that the input number of copies to make exceeds the number of remaining allowable copies, the printing apparatus 100 displays a warning message 1201 shown in FIG. 12 on the LCD panel 1002 (step S607), and processing returns to step S605. In FIG. 12, the LCD panel 1002 displays the warning message 1201 to notify the user that the input number of copies to make exceeds the number of remaining allowable copies. When the user selects a “Confirm” key, the warning message 1201 is no longer displayed.

Note that in FIG. 6, an ordinary paper sheet is used for printing when the RF tag 300 is not included and embedded in the scanned original document. If the RF tag 300 is not included and embedded in the scanned original document, copying of that original document may be inhibited, and only an original document having an embedded RF tag 300 may be copied.

In addition, in FIG. 6, the copy inhibit flag 413 of the RF tag 300 is set “on” when the number of copies made 412 has reached the total number of allowable copies 411. However, the copy allowance information 410 may include a period of allowance of copying, and the copy inhibit flag 413 may be set “on” when the period of allowance of coping has elapsed at the time of copying processing. In addition, the processing in FIG. 6 may be performed as the processing of the period of allowance of copying.

According to the processing illustrated in FIG. 6, it is determined, based on the copy inhibit flag 413 read from the RF tag 300 embedded in the original document, whether copying of the scanned original document is inhibited. Thus, copying of a printed product can be restricted.

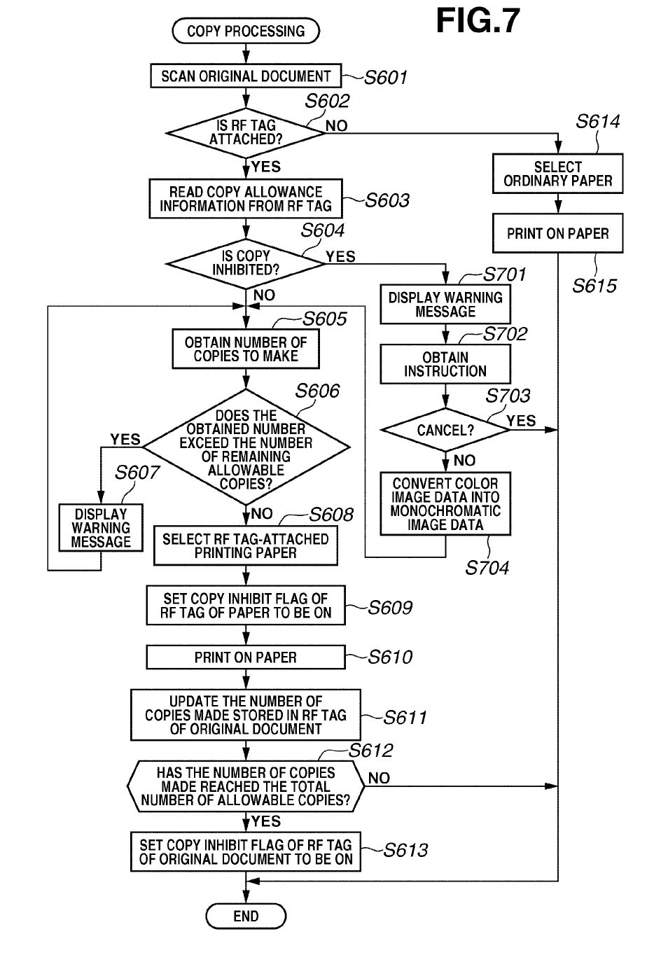

FIG. 7 is a flow chart illustrating processing performed in a modification of the embodiment of the copying processing shown in FIG. 6.

The processing shown in FIG. 7 differs from the processing in FIG. 6 only in the point that the processing of steps S701 through S704 is performed instead of the processing of step S616.

In the processing shown in FIG. 7, when copying of a color original document is inhibited, monochromatic copying is performed instead.

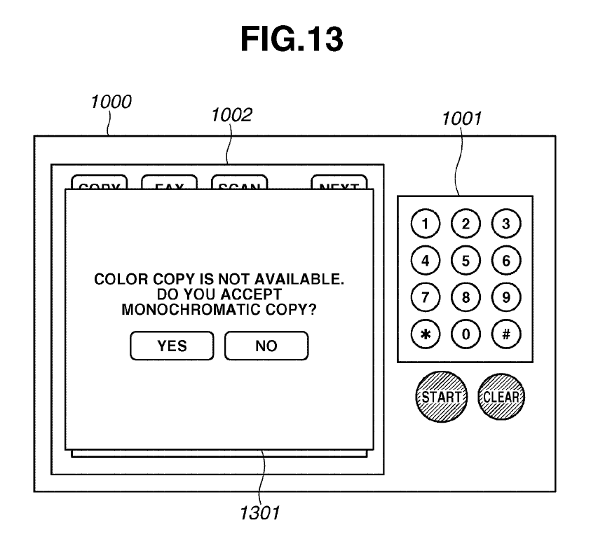

In FIG. 7, the printing apparatus 100 determines whether copying of the scanned original document is inhibited based on the copy inhibit flag 413 (step S604). If copying of the scanned original document is inhibited, the printing apparatus 100 displays a warning message 1301 shown in FIG. 13 on the LCD panel 1002 (step S701). In FIG. 13, the warning message 1301 notifies the user that color copy is inhibited and prompts the user to issue an instruction for performing monochromatic copy or for canceling the copying operation. The instruction for performing monochromatic copy or canceling the copying operation is inputted by the user selecting a “Yes” key or “No” key.

Returning to FIG. 7, the printing apparatus 100 obtains an instruction for performing monochromatic copy or canceling the copying operation input by the user (step S702), and determines whether the copying operation has been canceled based on the obtained instruction (step S703). If the copying operation is canceled, processing ends. If it is determined in step S703 that the copying operation is not canceled, the printing apparatus 100 converts color image data read in step S601 into monochromatic image data (step S704), and processing proceeds to step S605. The rest of the processing of FIG. 7 is similar to that in FIG. 6, and thus an explanation thereof is omitted herein.

According to the processing illustrated in FIG. 7, when copying of the scanned original document is inhibited, a message indicating that color copying thereof is inhibited is provided to the user. In addition, the warning message 1301 for prompting the instruction for performing monochromatic copying or canceling the copying operation is displayed on the LCD panel 1002. Accordingly, copying of a printed product can be restricted while maintaining convenience for the user.

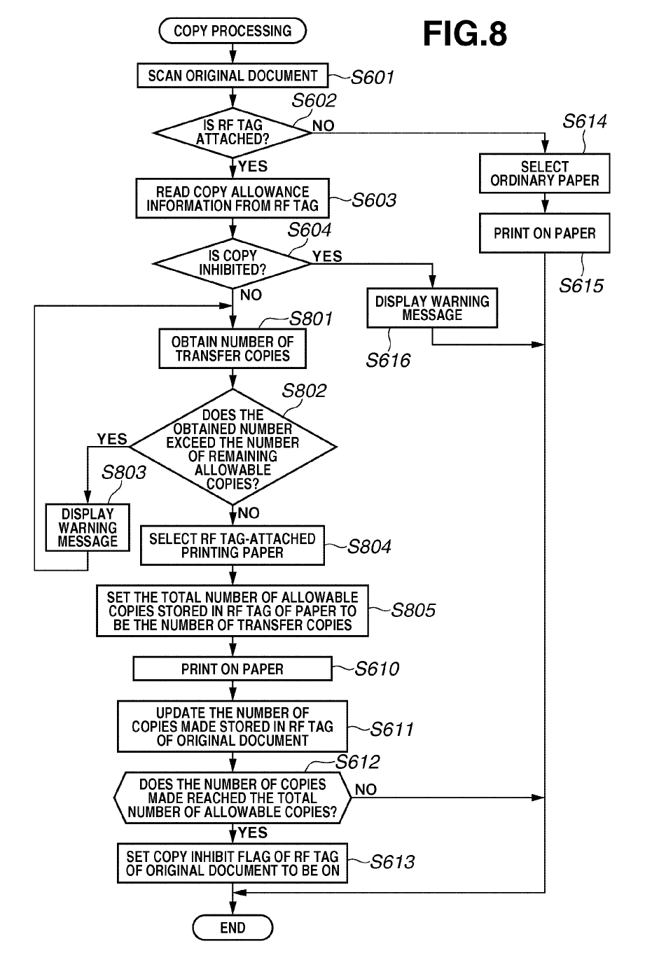

FIG. 8 is a flow chart illustrating an example of a procedure performed in another modification of the embodiment of the copying processing shown in FIG. 6.

The processing illustrated in FIG. 8 differs from the processing illustrated in FIG. 6 only in the point that the processing of steps S801 through S805 is performed instead of the processing of steps S605 through S609.

In the processing shown in FIG. 8, the copy allowance information of the original document is transferred to a paper sheet used for printing.

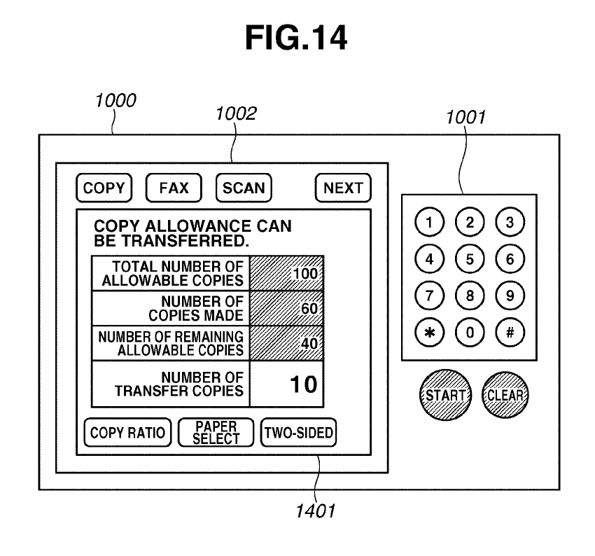

In FIG. 8, the printing apparatus 100 determines whether copying of the scanned original document is inhibited based on the copy inhibit flag 413 (step S604). If copying of the scanned original document is not inhibited, the printing apparatus 100 obtains the number of transfer copies input by the user via the operation unit 106 (step S801). The number of transfer copies is input via a transfer copy number input screen 1401 shown in FIG. 14.

In FIG. 14, the LCD panel 1002 displays the transfer copy number input screen 1401, including the total number of allowable copies, the number of copies made, the number of remaining allowable copies, and the number of transfer copies. The total number of allowable copies and the number of copies made are displayed based on the total number of allowable copies 411 and the number of copies made 412 read in step S603. The number of remaining allowable copies is the remaining number of copies obtained by subtracting the number of copies made from the total number of allowable copies. The number of transfer copies is input by the user via the numeric keypad 1001.

Referring back to FIG. 8, the printing apparatus 100 determines whether the input number of transfer copies exceeds the number of remaining allowable copies (step S802). If it is determined that the input number of transfer copies does not exceed the number of remaining allowable copies, the printing apparatus 100 selects the RF tag-attached printing paper sheet 400 as a paper sheet to be used for printing (step S804). Then, the printing apparatus 100, using the RF tag control unit 200, sets the total number of allowable copies to be the number of transfer copies and writes the copy allowance information 410 into the RF tag 300 embedded in the RF tag-attached printing paper sheet 400 (step S805). In addition, the printing apparatus 100, using the printer 110, prints the image data read from the original document on the RF tag-attached printing paper sheet 400 (step S610). The rest of the processing of FIG. 8 is similar to that shown in FIG. 6, and an explanation thereof is omitted herein.

If, it is determined in step S802 that the input number of transfer copies exceeds the number of remaining allowable copies, the printing apparatus 100 displays a warning message 1201 shown in FIG. 12 on the LCD panel 1002 (step S803), and processing returns to step S801.

According to the processing illustrated in FIG. 8, the copy allowance information 410 is written into the RF tag 300 while setting the number of transfer copies to the total number of allowable copies 411. Thus, copying of a printed product can be restricted, and the copy allowance information can be added to a printed product.

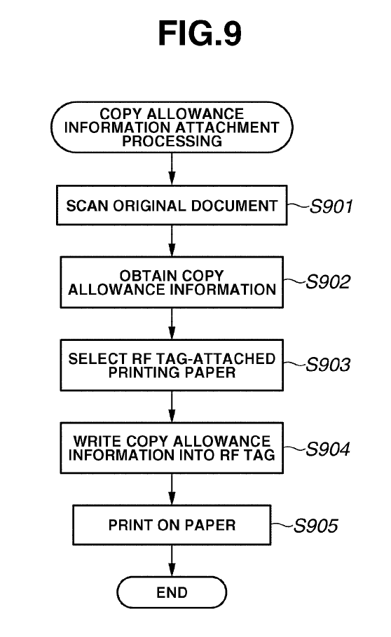

FIG. 9 is a flow chart illustrating an example of a procedure performed in a modification of the copy allowance information attachment processing shown in FIG. 5.

In this processing, when image data is read from an original document using the scanner 109 and the read image data is printed, the copy allowance information 410 is added to a printed product.

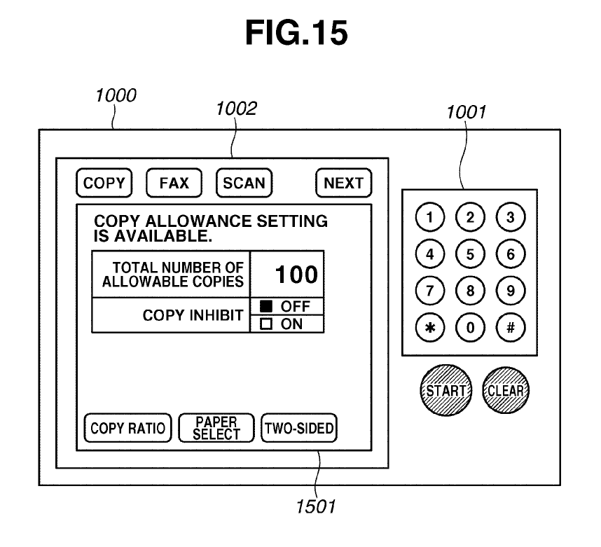

In FIG. 9, the printing apparatus 100, using the scanner 109, scans an original document and reads image data from the original document (step S901). Then, the printing apparatus 100 obtains the copy allowance information 410 to be added to a printed product, which is input by the user via the operation unit 106 (step S902). The copy allowance information 410 is input through a copy allowance information input screen 1501 shown in FIG. 15.

In FIG. 15, the LCD panel 1002 displays the copy allowance information input screen 1501, including the total number of allowable copies and the copy inhibit flag. The user via the numeric keypad 1001 inputs the total number of allowable copies. On/off of the copy inhibit flag is input by the user selecting an “On” key or “Off” key in the field of the copy inhibit flag.

Referring back to FIG. 9, the printing apparatus 100 selects the RF tag-attached printing paper sheet 400 as a paper sheet to be used for printing (step S903). Then, the printing apparatus 100, using the RF tag control unit 200, writes the copy allowance information 410 obtained in step S902 into the RF tag 300 of the RF tag-attached printing paper sheet 400 (step S904). In addition, the printing apparatus 100, using the printer 110, prints the image data read from the original document on the RF tag-attached printing paper sheet 400 (step S905). Then, the processing ends.

According to the processing illustrated in FIG. 9, the copy allowance information 410 input by the user in printing the read image is written into the RF tag 300. Thus, the copy allowance information may be added to a printed product.

As described above, copy allowance information is obtained from a printed product, and whether copying of the printed product is inhibited is determined based on the obtained copy allowance information. Accordingly, copying of the printed product can be restricted.

The present invention can also be achieved by providing a system or an apparatus with a storage medium storing program code of software implementing the functions of the above-described embodiments and by reading and executing the program code stored in the storage medium with a computer (CPU or MPU) of the system or apparatus.

In this case, the program code itself, which is read from the storage medium, implements the functions of the embodiments mentioned above, and accordingly, the storage medium storing the program code configures the present invention.

The storage medium for supplying such program code includes, for example, a floppy disk, a hard disk, an optical disk, a magneto-optical disk, a CD-ROM, a CD-R, a CD-RW, a DVD-ROM, a DVD-RAM, a DVD-RW, a DVD+RW, a magnetic tape, a nonvolatile memory card, a ROM, etc. Alternatively, the program code can be downloaded via a network.

In addition, the functions according to the embodiments described above can be implemented not only by executing the program code read by the computer, but also implemented by the processing in which an OS (operating system) or the like carries out a part of or the whole of the actual processing on the basis of the instruction given by the program code.

In another aspect of an embodiment of the present invention, after the program code read from the storage medium is written in a memory provided in a function expanding board inserted in the computer or a function expanding unit connected to the computer, a CPU and the like provided in the function expanding board or the function expanding unit can carry out a part of or the whole of the processing to implement the functions of the embodiments described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-163190 filed Jun. 2, 2005, which is hereby incorporated by reference herein in its entirety.

What is claimed is:

1. An information processing apparatus comprising:
a reading unit configured to read an image on an original document;
an obtaining unit configured to obtain copy information added to the original document;
a printing unit configured to print the image read by the reading unit in accordance with the copy information obtained by the obtaining unit; and
an updating unit configured to update the copy information added to the original document in accordance with printing performed by the printing unit.

2. The information processing apparatus according to claim 1, wherein the updating unit rewrites the copy information added to the original document.

3. The information processing apparatus according to claim 1, further comprising a determination unit configured to determine, based on the copy information obtained by the obtaining unit, whether copying of the original document is inhibited.

4. The information processing apparatus according to claim 3, wherein, if the determination unit determines that copying is inhibited, the printing unit does not print the image.

5. The information processing apparatus according to claim 3, wherein if the determination unit determines that copying is inhibited, the printing unit prints a color original document as a monochromatic original document.

6. The information processing apparatus according to claim 1, further comprising:
a determination unit configured to determine whether the copy information is added to the original document; and
a selection unit configured to select, based on a determination by the determination unit, a paper sheet to be used to print the image.

7. The information processing apparatus according to claim 1, further comprising an addition unit configured to add copy information to a printing medium to be used to print an image by the printing unit.

8. The information processing apparatus according to claim 7, wherein the addition unit is configured to add copy information indicating inhibition of copying to the printing medium.

9. The information processing apparatus according to claim 7, wherein the addition unit is configured to add copy information specified by a user to the printing medium.

10. The information processing apparatus according to claim 1, further comprising a recognition unit configured to recognize, based on the copy information obtained by the obtaining unit, a number of remaining allowable copies of the original document.

11. The information processing apparatus according to claim 10, further comprising a control unit configured to control, based on the number of remaining allowable copies recognized by the recognition unit and a number of copies to make specified by a user, whether printing by the printing unit is executed.

12. The information processing apparatus according to claim 10, wherein the updating unit is configured to update, based on the number of remaining allowable copies recognized by the recognition unit and a number of copies printed by the printing unit, the copy information to information indicating inhibition of copying of the original document.

13. The information processing apparatus according to claim 1, wherein the copy information includes at least one of a total number of allowable copies of the original document, a number of copies made of the original document, information indicating that copying of the original document is inhibited, and information indicating a time period in which copying of the original document is allowed.

14. A control method for use in copying an original document, the control method comprising:
obtaining copy information added to an original document;
copying the original document based on the copy information; and
updating the copy information added to the original document based on the copying of the original document.

15. Computer-executable process steps for executing the method of claim 14, the computer-executable process steps comprising:
obtaining copy information added to an original document;
copying an original document based on copy information obtained from an original document; and
updating the copy information added to the original document based on the copying of the original document.

16. Computer-readable storage medium storing computer-executable process steps, wherein the computer-executable process steps execute the method of claim 14.
